(19) United States
(12) Patent Application Publication
(10) Pub. No.: US 2019/0129221 A1
(43) Pub. Date: May 2, 2019

(54) LIQUID CRYSTAL DISPLAY PANEL AND MANUFACTURING METHOD THEREOF

(71) Applicants: HKC Corporation Limited; Chongqing HKC Optoelectronics Technology Co., Ltd.

(72) Inventor: Yu-Jen CHEN, Chongqing (CN)

(21) Appl. No.: 15/735,342

(22) PCT Filed: Apr. 14, 2017
(86) PCT No.: PCT/CN2017/080551

§ 371 Date: Dec. 11, 2017

(30) Foreign Application Priority Data
Dec. 29, 2016 (CN) 201611246423.7

(51) Int. Cl. G02F 1/1339; G02F 1/1337; G02F 1/1335; G02F 1/1368; G02F 1/1343

(52) U.S. Cl. CPC G02F 1/13394; G02F 1/1337; G02F 1/133516; G02F 1/136227; G02F 1/13439; G02F 2001/133776; G02F 1/1368

(57) ABSTRACT

The present disclosure provides a liquid crystal display (LCD) panel and a manufacturing method thereof. The manufacturing method includes: providing a first substrate, where the first substrate includes a first electrode; providing a second substrate, where the second substrate includes a second electrode and color filters (CFs), and the second electrode is formed on the color filters; forming a plurality of photo spacers (PS) on the color filters, where an angle between the photo spacers and the second electrode is equal to or less than 90 degrees; and forming a liquid crystal layer between the first substrate and the second substrate.

### BACKGROUND

### Technical Field

The present disclosure relates to a liquid crystal display panel and a manufacturing method thereof, and in particular, to a liquid crystal display panel for avoiding formation of an electrode on a photo spacer (PS), and a manufacturing method thereof.

### Related Art

In recent years, as science technologies develop, many different display devices such as liquid crystal displays (LCD) or electro luminenscence (EL) display devices have been widely applied to flat panel displays. Taking liquid crystal displays as an example, most liquid crystal displays are backlight type liquid crystal displays. The backlight type liquid crystal display includes a liquid crystal display panel and a backlight module. The liquid crystal display panel includes two transparent substrates and a liquid crystal sealed between the two substrates.

As the science technologies develop, liquid crystal displays having many advantages such as power saving, no radiation, a small volume, low power consumption, a flat square, high resolution, and stable image quality, especially current various information products such as mobile phones, notebook computers, digital cameras, PDAs, and liquid crystal screens are becoming popular, greatly increasing a demand quantity of LCDs. Therefore, how to promote process efficiency and simplify a process flow is a management problem that managers need to face with.

For manufacturing of a four-color color filters (CFs) of a conventional liquid crystal display panel, regardless of a general standard process of color filters or a process of color filters on array (COA), manufacturing of a photo spacer is required after a red/green/blue/white color resist is manufactured. A function of the photo spacer is to support an LCD cell gap. Consequently, more materials are used, management is difficult, a manufacturing process is complex, and device investment is higher.

In addition, to avoid formation of an electrode on the photo spacer, a color filter indium tin oxide mask (CF ITO mask) process is generally required, prolonging a manufacturing time and increasing investment on yellow light equipment.

### SUMMARY

Objectives of the present disclosure is to provide a liquid crystal display panel and a manufacturing method thereof, so as to avoid a short circuit caused by formation of an electrode on a photo spacer.

One of the objectives of the present disclosure is to provide a liquid crystal display panel. The liquid crystal display panel includes:
a first substrate, comprising a first electrode;
a second substrate, oppositely disposed with respect to the first substrate, where the second substrate comprises a second electrode and color filters, and the second electrode is formed on the color filters;
a plurality of photo spacers, located between the first substrate and the second substrate, and disposed on the color filters, where an angle between the photo spacers and the second electrode is equal to or less than 90 degrees; and
a liquid crystal layer, formed between the first substrate and the second substrate.

In an embodiment of the present disclosure, the first substrate further comprises a plurality of active switches, and the first electrode is formed on the plurality of active switches.

In an embodiment of the present disclosure, the angle between the photo spacers and the second electrode is less than 90 degrees.

In an embodiment of the present disclosure, at least some of the photo spacers on the color filters are inverted trapezoidal.

In an embodiment of the present disclosure, the angle between the photo spacers and the second electrode is equal to 90 degrees.

In an embodiment of the present disclosure, the photo spacers on the color filters are long rectangular.

In an embodiment of the present disclosure, the second substrate further comprises a plurality of active switches, and the color filters are formed on the plurality of active switches.

One of the objectives of the present disclosure is to provide a liquid crystal display panel manufacturing method. The manufacturing method includes:
providing a first substrate, where the first substrate comprises a first electrode;
providing a second substrate, where the second substrate comprises a second electrode and color filters, and the second electrode is formed on the color filters;
forming a plurality of photo spacers on the color filters, where an angle between the photo spacers and the second electrode is equal to or less than 90 degrees; and
forming a liquid crystal layer between the first substrate and the second substrate.

In an embodiment of the present disclosure, when the photo spacers are formed, the photo spacers are excessively etched, so that the angle between the photo spacers and the second electrode is equal to or less than 90 degrees.

One of the objectives of the present disclosure is to provide a liquid crystal display panel, including:
a first substrate, comprising a first electrode and a plurality of active switches, where the first electrode is formed on the plurality of active switches;
a second substrate, oppositely disposed with respect to the first substrate, where the second substrate comprises a second electrode and color filters, and the second electrode is formed on the color filters;
a plurality of photo spacers, located between the first substrate and the second substrate, and disposed on the color filters, where an angle between the photo spacers and the second electrode is equal to or less than 90 degrees; and
a liquid crystal layer, formed between the first substrate and the second substrate, where
either the first substrate or the second substrate comprises color filters, the color filters comprise a plurality of photoresist layers disposed in parallel, and a material of one of the plurality of photoresist layers is the same as a material of the photo spacers;
when the angle between the photo spacers and the second electrode is less than 90 degrees, at least some of the photo spacers on the color filters are inverted trapezoidal; and
when the angle between the photo spacers and the second electrode is equal to 90 degrees, the photo spacers on the color filters are long rectangular.

Another objective of the present disclosure is to provide a liquid crystal display panel manufacturing method, including: providing a second substrate, where color filters are formed on a second base, a plurality of photo spacers is formed on the second base, the color filters including a plurality of photoresist layers such as a first-color photoresist layer to a fourth-color photoresist layer disposed in parallel, and a material of one of the first-color photoresist layer to the fourth-color photoresist layer being the same as a material of the photo spacers, and a second electrode is formed on the color filters, thereby implementing the second substrate; providing a first substrate oppositely disposed with respect to the second substrate, where the photo spacers are located between the first substrate and the second substrate, and are configured to define a liquid crystal compartment and fill the liquid crystal compartment; and forming a liquid crystal layer between the first substrate and the second substrate. In addition, when the color filters are manufactured, a white pixel material is replaced with a new material of the photo spacers by adjusting a brightness sensitive degree, a penetration ratio, and chromaticity of the material of the photo spacers. Therefore, when a white pixel is fabricated, manufacturing of the photo spacers is completed, and a required level difference of the photo spacers is reserved.

Still another objective of the present disclosure is to provide a liquid crystal display panel manufacturing method, including: providing a first substrate, where color filters are formed on a first base, a plurality of photo spacers is formed on the first base, the color filters including a plurality of photoresist layers such as a first-color photoresist layer to a fourth-color photoresist layer disposed in parallel, and a material of one of the first-color photoresist layer to the fourth-color photoresist layer being the same as a material of the photo spacers, a first insulation layer is formed on the color filters, and a first electrode is formed on the first insulation layer, thereby implementing the first substrate; providing a second substrate oppositely disposed with respect to the first substrate, where the photo spacers are located between the first substrate and the second substrate, and are configured to define a liquid crystal compartment and fill the liquid crystal compartment; and forming a liquid crystal layer between the first substrate and the second substrate. In addition, when color filters on array is manufactured, a white pixel material is replaced with a new material of the photo spacers by adjusting a brightness sensitive degree, a penetration ratio, and chromaticity of the material of the photo spacers. Therefore, when a white pixel is fabricated, manufacturing of the photo spacers is completed, and a required level difference of the photo spacers is reserved.

The technical problems of the present disclosure may be further resolved by using the following technical measures.

In an embodiment of the present disclosure, the second substrate includes a second base, color filters located on the second base, and a second electrode located on the color filters.

In an embodiment of the present disclosure, the second substrate further includes a light shield layer located approximately right above the photo spacers.

In an embodiment of the present disclosure, the second substrate further includes an adjustment layer being in contact with the photo spacers.

In an embodiment of the present disclosure, the first substrate includes the first base, the color filters located on the first base, the first insulation layer located on the color filters, and the first electrode located on the first insulation layer.

In an embodiment of the present disclosure, the manufacturing method further includes: when color filters are manufactured, replacing a white pixel material with a new material of the photo spacers by adjusting a brightness sensitive degree, a penetration ratio, and chromaticity of the material of the photo spacers. Therefore, when a white pixel is fabricated, manufacturing of the photo spacers is completed, and a required level difference of the photo spacers is reserved.

In an embodiment of the present disclosure, the manufacturing method further includes: when color filters on array is manufactured, replacing a white pixel material with a new material of the photo spacers by adjusting a brightness sensitive degree, a penetration ratio, and chromaticity of the material of the photo spacers. Therefore, when a white pixel is fabricated, manufacturing of the photo spacers is completed, and a required level difference of the photo spacers is reserved.

In the present disclosure, the photo spacers are inverted trapezoidal (having an undercut) or resemble a shape of 90 degrees, to enable indium tin oxide (ITO) to be discontinuous at positions of the photo spacers and to be broken naturally. In this way, a CF ITO mask process is not required, shortening a manufacturing time and reducing investment on yellow light equipment.

### BRIEF DESCRIPTION OF THE DRAWINGS

FIG. 1a is a schematic diagram of a cross section of an exemplary liquid crystal display panel;

FIG. 1b is a schematic diagram of a cross section during manufacturing of an exemplary liquid crystal display panel;

FIG. 2a is a schematic diagram of a cross section during manufacturing of color filters of a liquid crystal display panel applying a method according to the present disclosure;

FIG. 2b is a schematic diagram of a cross section during manufacturing of color filters on array of a liquid crystal display panel applying a method according to the present disclosure;

FIG. 3 is a schematic diagram of a cross section during manufacturing of color filters of a liquid crystal display panel applying another embodiment of a method according to the present disclosure;

FIG. 4 is a schematic diagram of a cross section during manufacturing of color filters of a liquid crystal display panel applying still another embodiment of a method according to the present disclosure; and

FIG. 5 is a schematic diagram of a photo spacer in an embodiment according to the present disclosure.

### DETAILED DESCRIPTION

The following embodiments are described with reference to the accompanying drawings, which are used to exemplify specific embodiments for implementation of the present disclosure. Terms about directions mentioned in the present disclosure, such as “on”, “below”, “front”, “back”, “left”, “right”, “in”, “out”, and “side surface” merely refer to directions of the accompanying drawings. Therefore, the used terms about directions are used to describe and understand the present disclosure, and are not intended to limit the present disclosure.

The accompanying drawings and the description are considered to be essentially exemplary, rather than limitative. In figures, units with similar structures are represented by using a same reference number. In addition, for understanding and ease of description, a size and a thickness of each component shown in the accompanying drawings are arbitrarily shown, but the present disclosure is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of a gravity direction.

To further describe the technical means adopted in the present disclosure to achieve the preset invention objective and effects thereof, specific implementations, structures, features, and effects of a liquid crystal display panel and a manufacturing method thereof provided according to the present disclosure are described in detail below with reference to the drawings and preferred embodiments.

The liquid crystal display panel in the present disclosure may include a first substrate, a second substrate, and a liquid crystal layer formed between the two substrates. The first substrate and the second substrate may be, for example, an active switch array substrate and color filters substrate, but are not limited thereto. In an embodiment, an active switch (for example, a thin film transistor (TFT)) and color filters may also be formed on a same substrate.

In an embodiment, the liquid crystal display panel in the present disclosure may be a curved display panel.

The liquid crystal display panel in the present disclosure may be disposed on a backlight module, to form a liquid crystal display apparatus.

In some embodiments, the backlight module is, for example, an edge backlight module, and is disposed opposite to the liquid crystal display panel, to form the liquid crystal display apparatus. The backlight module may include a backplane, a light source, a light guide plate, a reflection layer, and an optical membrane. The backplane is configured to fix the light source, the light guide plate, the reflection layer, and the optical membrane. The light source is disposed on a side of the light guide plate, and is configured to emit lateral light to the light guide plate. The light guide plate guides the light to the outside. The reflection layer is disposed between the backplane and the light guide plate, and is configured to reflect the light from the light source. The optical membrane is disposed on the light guide plate, to improve an optical effect.

In some embodiments, the light source may be, for example, a cold cathode fluorescent lamp (CCFL), a hot cathode fluorescent lamp (HCFL), a light-emitting diode (LED), an organic light emitting diode (OLED), a flat fluorescent lamp (FFL), an electro-luminescence (EL) component, a light bar (Light Bar), a laser source, or any combination thereof.

In some embodiments, the optical membrane of the backlight module is, for example, a diffusion sheet, a prism sheet, a turning prism sheet (Turning Prism Sheet), a brightness enhancement film (BEF), a dual brightness enhancement film (DBEF), a diffused reflective polarizer film (DRPF), or any combination thereof, and is disposed on the light guide plate to improve an optical effect of light from the light guide plate.

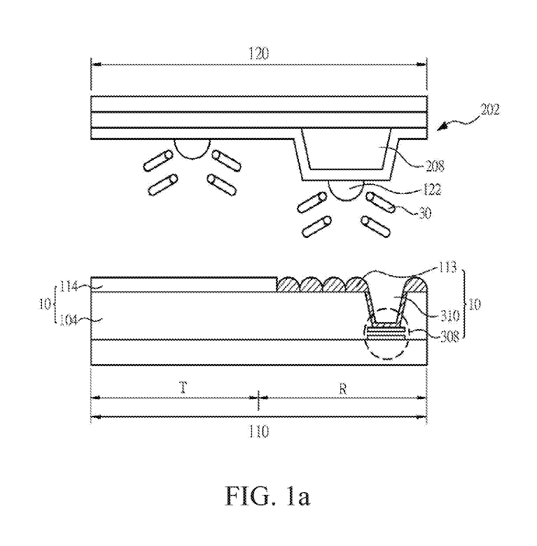

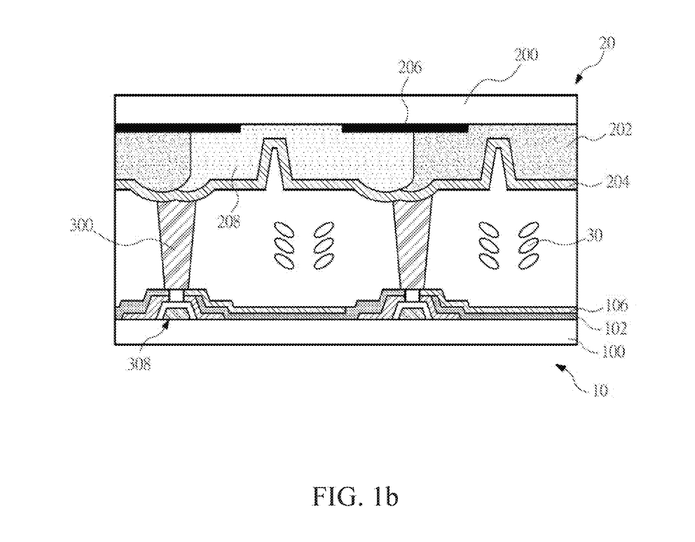

FIG. 1a is a schematic diagram of a cross section of an exemplary liquid crystal display panel, and FIG. 1b is a schematic diagram of a cross section during manufacturing of an exemplary liquid crystal display panel. Referring to FIG. 1a and FIG. 1b, for the technology development of current liquid crystal displays, a dual gap (dual gap) transflective MVA liquid crystal display is taken as an example. Generally, on the dual gap transflective liquid crystal display, an adjustment layer 208 is disposed in a reflective region R. As shown in FIG. 1a, the adjustment layer may be disposed on a CFs substrate side or a TFT substrate side. As shown in FIG. 1a, a basic structure of the dual gap transflective MVA liquid crystal display includes a first substrate 10, a color filter substrate 202, and a liquid crystal layer 30. The first substrate 10 has a plurality of pixel regions 110, and each pixel region 110 includes a reflective region R and a transmissive region T. The color filter substrate 202 also has a plurality of pixel regions 120. The pixel regions 120 respectively correspond to the plurality of pixel regions 110 on the first substrate, and each pixel region 120 includes an adjustment layer 208 at a position corresponding to the reflective region R. The liquid crystal layer 30 is disposed between the first substrate 10 and the color filter substrate 202.

Still referring to FIG. 1a and FIG. 1b, at least one active switch may be disposed in each pixel region 110 on the first substrate 10. For example, a thin film transistor and a storage capacitor 308 are disposed under the reflective region R. Next, a flat layer 104 is formed on an upper surface of the first substrate 10. Then, an uneven surface on the reflective region R is made on the flat layer 104, and then is plated with a metal with high reflectivity (such as aluminum or silver) to serve as a reflective electrode 113, and the transmissive region T of each pixel region 110 includes a transparent electrode 114. It should be noted that, the reflective region R of each pixel region 110 of the first substrate 10 further includes a contact hole 310, used to electrically connect the reflective electrode 113 and the storage capacitor 308. In addition, the color filter substrate 202 further includes an alignment protrusion (PR) 122 at a position corresponding to the reflective region R and the transmissive region T of the first substrate 10. Because the alignment protrusion 122 changes distribution of power lines, liquid crystal molecules lean towards the direction of the alignment protrusion 122 to generate a multi-domain liquid crystal alignment effect, to implement a wide viewing angle technology, and improve a gray-scale inversion problem existing during single-domain liquid crystal alignment. As shown in FIG. 1b, generally, when the first substrate 10 and the color filter substrate 202 are assembled, the color filter substrate 202 further includes a photo spacer 300 to fix a cell gap between panels. A plurality of platforms corresponding to the photo spacer 300 is designed on a side of the first substrate 10, so that the photo spacer 300 can more stably maintain the cell gap between panels. In the foregoing description, an example of a reflective wide viewing angle liquid crystal display panel is used, but the application scope of the present disclosure is not limited thereto. The present disclosure may be further applied to a dual gap transflective liquid crystal display panel and a single gap transflective liquid crystal display panel.

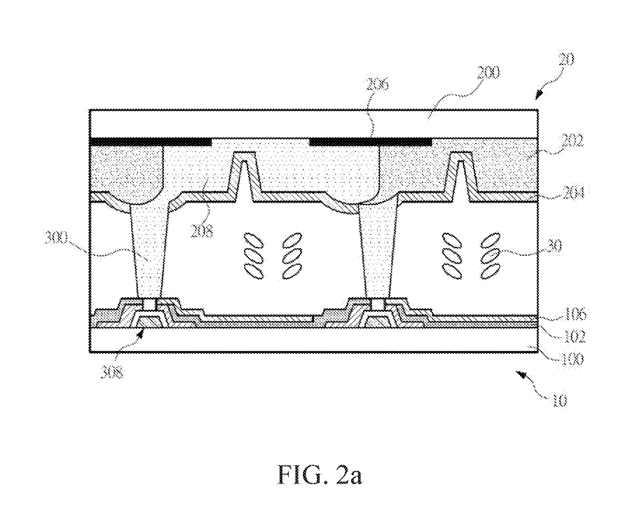

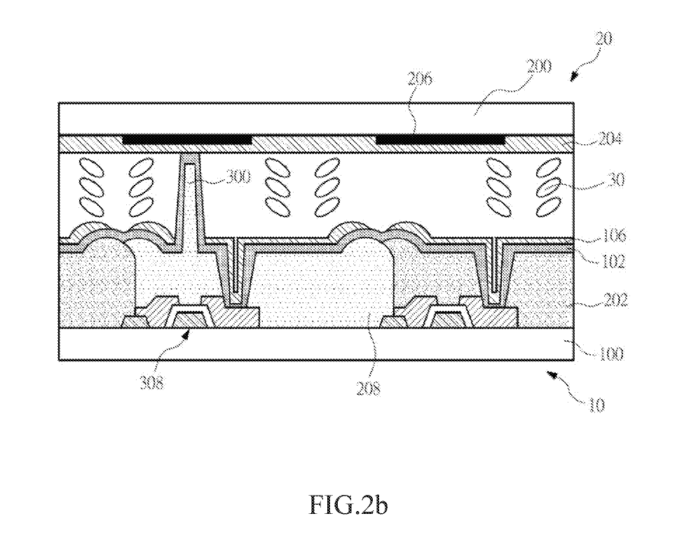

FIG. 2a is a schematic diagram of a cross section during manufacturing of color filters 202 of a liquid crystal display panel applying a method according to the present disclosure. Referring to FIG. 2a, in an embodiment of the present disclosure, the liquid crystal display panel includes: a first substrate 10, having a plurality of pixel regions, the first substrate 10 including a first base 100, a first insulation layer 102 formed on the first base 100, and a first electrode 106 formed on the first insulation layer 102; a second substrate 20, oppositely disposed with respect to the first substrate 10; a plurality of photo spacers 300, located between the first substrate 10 and the second substrate 20 and configured to define a liquid crystal compartment; and a liquid crystal layer 30, located between the first substrate 10 and the second substrate 20 and filling the liquid crystal compartment. Either the first substrate 10 or the second substrate 20 includes color filters 202, and the color filters 202 include a plurality of photoresist layers disposed in parallel. The color filters 202 may include, for example, a first-color photoresist layer, a second-color photoresist layer, a third-color photoresist layer, and a fourth-color photoresist layer. In some embodiments, for example, the first-color photoresist layer, the second-color photoresist layer, the third-color photoresist layer, and the fourth-color photoresist layer may be red, green, blue, and white photoresist layers, and a material of one of the first-color photoresist layer, the second-color photoresist layer, the third-color photoresist layer, and the fourth-color photoresist layer is the same as a material of the photo spacers 300. The second substrate 20 includes a second base 200, color filters 202 located on the second base 200, a second electrode 204 located on the color filters 202. The second substrate 20 further includes a light shield layer 206 (for example, a black matrix (BM)) located approximately right above the photo spacers 300. The second substrate 20 further includes an adjustment layer 208 being in contact with the photo spacers 300.

In some embodiments, a material of the photo spacers 300 may be the same as a material of a white photoresist layer of the color filters 202.

In an embodiment, for example, a plurality of photoresist layers of the color filters 202 may also be photoresist layers in yellow or another color.

FIG. 2b is a schematic diagram of a cross section during manufacturing of color filters 202 on array of a liquid crystal display panel applying a method according to the present disclosure. Referring to FIG. 2b, in an embodiment of the present disclosure, the liquid crystal display panel includes: a first substrate 10, having a plurality of pixel regions, the first substrate 10 including a first base 100, color filters 202, a first insulation layer 102 formed on the color filters 202, and a first electrode 106 formed on the first insulation layer 102; a second substrate 20, oppositely disposed with respect to the first substrate 10; and a liquid crystal layer 30, located between the first substrate 10 and the second substrate 20. The second substrate 20 further includes a light shield layer 206 (for example, a BM).

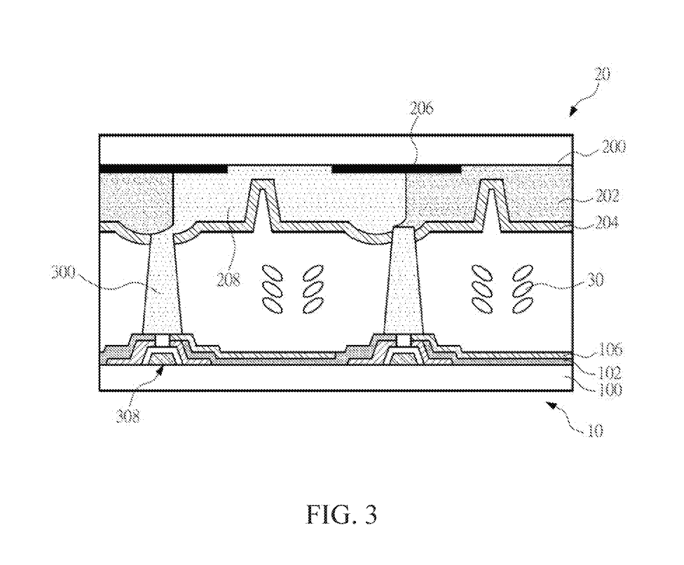

FIG. 3 is a schematic diagram of a cross section during manufacturing of color filters of a liquid crystal display panel applying another embodiment of a method according to the present disclosure. Referring to FIG. 3, in an embodiment of the present disclosure, the liquid crystal display panel includes: a first substrate 10, having a plurality of pixel regions, the first substrate 10 including a first base 100, a first insulation layer 102 formed on the first base 100, and a first electrode 106 formed on the first insulation layer 102; a second substrate 20, oppositely disposed with respect to the first substrate 10; a plurality of photo spacers 300, located between the first substrate 10 and the second substrate 20 and configured to define a liquid crystal compartment; and a liquid crystal layer 30, located between the first substrate 10 and the second substrate 20 and filling the liquid crystal compartment. Either the first substrate 10 or the second substrate 20 includes color filters 202, and the color filters 202 includes a plurality of photoresist layers disposed in parallel. The color filters 202 may include, for example, a first-color photoresist layer, a second-color photoresist layer, a third-color photoresist layer, and a fourth-color photoresist layer. In some embodiments, for example, the first-color photoresist layer, the second-color photoresist layer, the third-color photoresist layer, and the fourth-color photoresist layer may be red, green, blue, and white photoresist layers, and a material of one of the first-color photoresist layer, the second-color photoresist layer, the third-color photoresist layer, and the fourth-color photoresist layer is the same as a material of the photo spacers 300. The second substrate 20 includes a second base 200, color filters 202 located on the second base 200, a second electrode 204 located on the color filters 202. The second substrate 20 further includes a light shield layer 206 (for example, a BM) located approximately right above the photo spacers 300. The second substrate 20 further includes an adjustment layer 208 being in contact with the photo spacers 300. In addition, according to a development adjustment process and a sensitometric characteristic of a material of the photo spacers 300, the photo spacers 300 are inverted trapezoidal (having an undercut) or resemble a shape of 90 degrees, to enable ITO to be discontinuous at positions of the photo spacers 300 and to be broken naturally. In this way, a CF ITO mask process is not required, shortening a manufacturing time and reducing investment on yellow light equipment.

In some embodiments, an angle between the photo spacers 300 and the second electrode 204 may be equal to or less than 90 degrees, to avoid formation of the second electrode 204 on the photo spacers 300, thereby avoiding a short circuit between the second electrode 204 and the first electrode 106 on the photo spacers 300.

In some embodiments, the liquid crystal display panel in the present disclosure includes: a first substrate, comprising a first electrode; a second substrate, oppositely disposed with respect to the first substrate, where the second substrate comprises a second electrode and color filters, and the second electrode is formed on the color filters; a plurality of photo spacers, located between the first substrate and the second substrate, and disposed on the color filters, where an angle between the photo spacers and the second electrode is equal to or less than 90 degrees; and a liquid crystal layer, formed between the first substrate and the second substrate.

In an embodiment of the present disclosure, the first substrate 10 further includes a plurality of active switches, and the first electrode 106 may be formed on the plurality of active switches.

In an embodiment of the present disclosure, the second substrate 20 further includes a plurality of active switches, and the color filters 202 may be formed on the plurality of active switches.

In an embodiment of the present disclosure, as shown in FIG. 3, the angle between the photo spacers and the second electrode is less than 90 degrees (for example, 75 degrees), and the photo spacers 300 on the color filters are inverted trapezoidal.

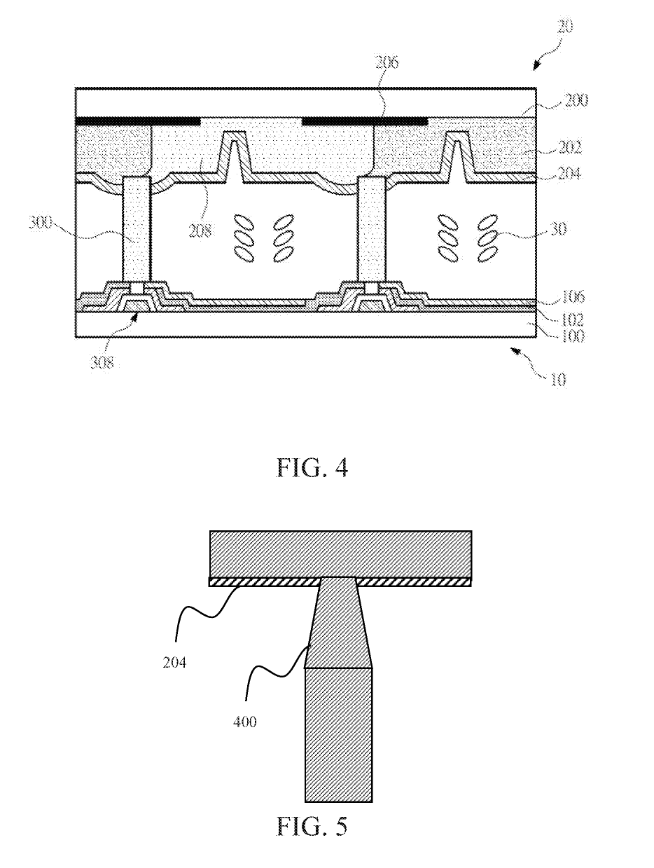

FIG. 4 is a schematic diagram of a cross section during manufacturing of color filters of a liquid crystal display panel applying still another embodiment of a method according to the present disclosure. Referring to FIG. 4, in an embodiment of the present disclosure, the liquid crystal display panel includes: a first substrate 10, having a plurality of pixel regions, the first substrate 10 including a first base 100, a first insulation layer 102 formed on the first base 100, and a first electrode 106 formed on the first insulation layer 102; a second substrate 20, oppositely disposed with respect to the first substrate 10; a plurality of photo spacers 300, located between the first substrate 10 and the second substrate 20 and configured to define a liquid crystal compartment; and a liquid crystal layer 30, located between the first substrate 10 and the second substrate 20 and filling the liquid crystal compartment. Either the first substrate 10 or the second substrate 20 includes color filters 202, and the color filters 202 includes a first-color photoresist layer to a fourth-color photoresist layer disposed in parallel. A material of one of the first-color photoresist layer to the fourth-color photoresist layer is the same as a material of the photo spacers 300. The second substrate 20 includes a second base 200, color filters 202 located on the second base 200, a second electrode 204 located on the color filters 202. The second substrate 20 further includes a light shield layer 206 (for example, a BM) located approximately right above the photo spacers 300. The second substrate 20 further includes an adjustment layer 208 being in contact with the photo spacers 300. In addition, according to a development adjustment process and a sensitometric characteristic of a material of the photo spacers 300, the photo spacers 300 are inverted trapezoidal (having an undercut) or resemble a shape of 90 degrees, to enable ITO to be discontinuous at positions of the photo spacers 300 and to be broken naturally. In this way, a CF ITO mask process is not required, shortening a manufacturing time and reducing investment on yellow light equipment.

In some embodiments, a liquid crystal display panel in the present disclosure includes: a first substrate, including a first electrode; a second substrate, oppositely disposed with respect to the first substrate, where the second substrate includes a second electrode and color filters, and the second electrode is formed on the color filters; a plurality of photo spacers, located between the first substrate and the second substrate, and disposed on the color filters, where an angle between the photo spacers and the second electrode is equal to or less than 90 degrees; and a liquid crystal layer, formed between the first substrate and the second substrate.

In an embodiment of the present disclosure, the first substrate 10 further includes a plurality of active switches, and the first electrode 106 may be formed on the plurality of active switches.

In an embodiment of the present disclosure, the second substrate 20 further includes a plurality of active switches, and the color filters 202 may be formed on the plurality of active switches.

In an embodiment of the present disclosure, as shown in FIG. 4, the angle between the photo spacers and the second electrode may essentially be equal to 90 degrees, and the photo spacers 300 on the color filters are long rectangular.

FIG. 5 is a schematic diagram of a photo spacer in an embodiment according to the present disclosure. In an embodiment of the present disclosure, as shown in FIG. 5, an angle between a photo spacer and a second electrode is less than 90 degrees (for example, 75 degrees), and a part of the photo spacer 400 on the color filter close to the second electrode 204 is inverted trapezoidal.

In an embodiment of the present disclosure, a liquid crystal display panel manufacturing method according to the present disclosure includes: providing a second substrate 20, where color filters 202 are formed on a second base 200, a plurality of photo spacers 300 are formed on the second base 200, the color filters 202 including a plurality of photoresist layers such as a first-color photoresist layer to a fourth-color photoresist layer disposed in parallel, and a material of one of the first-color photoresist layer to the fourth-color photoresist layer being the same as a material of the photo spacers 300, and a second electrode 204 is formed on the color filters 202, thereby implementing the second substrate 20; providing a first substrate 10 oppositely disposed with respect to the second substrate 20, where the photo spacers 300 are located between the first substrate 10 and the second substrate 20 and are configured to define a liquid crystal compartment and fill the liquid crystal compartment; and forming a liquid crystal layer 30 between the first substrate 10 and the second substrate 20. In addition, when the color filters 202 is manufactured, a white pixel material is replaced with a new material of the photo spacers 300 by adjusting a brightness sensitive degree, a penetration ratio, and chromaticity of the material of the photo spacers 300. Therefore, when a white pixel is fabricated, manufacturing of the photo spacers 300 is completed, and a required level difference of the photo spacers 300 is reserved. An advantage is reducing a process of the photo spacers 300.

In some embodiments of the present disclosure, the liquid crystal display panel manufacturing method according to the present disclosure may include:
providing a first substrate, where the first substrate includes a first electrode;
providing a second substrate, where the second substrate includes a second electrode and color filters, and the second electrode is formed on the color filters;
forming a plurality of photo spacers on the color filters, where an angle between the photo spacers and the second electrode is equal to or less than 90 degrees; and
forming a liquid crystal layer between the first substrate and the second substrate.

In an embodiment of the present disclosure, when the photo spacers 300 are formed, the photo spacers 300 may be excessively etched, so that the angle between the photo spacers 300 and the second electrode is equal to or less than 90 degrees.

In an embodiment of the present disclosure, a liquid crystal display panel manufacturing method according to the present disclosure includes: providing a first substrate 10, where color filters 202 is formed on a first base 100, a plurality of photo spacers 300 is formed on the first base 100, the color filters 202 including a plurality of photoresist layers such as a first-color photoresist layer, a second-color photoresist layer, a third-color photoresist layer, a fourth-color photoresist layer disposed in parallel, and a material of one of the first-color photoresist layer to the fourth-color photoresist layer being the same as a material of the photo spacers 300, for example, in some embodiments, the color filters 202 including red, green, blue, and white photoresist layers; next, a first insulation layer 102 is formed on the color filters 202, and a first electrode 106 is formed on the first insulation layer 102, thereby implementing the first substrate 10; providing a second substrate 20 oppositely disposed with respect to the first substrate, where the photo spacers 300 are located between the first substrate 10 and the second substrate 20, and are configured to define a liquid crystal compartment and fill the liquid crystal compartment; and forming a liquid crystal layer 30 between the first substrate 10 and the second substrate 20. In addition, when color filters 202 on array is manufactured, a white pixel material is replaced with a new material of the photo spacers 300 by adjusting a brightness sensitive degree, a penetration ratio, and chromaticity of the material of the photo spacers 300. Therefore, when a white pixel is fabricated, manufacturing of the photo spacers 300 is completed, and a required level difference of the photo spacers 300 is reserved. An advantage is reducing a process of the photo spacers 300.

In some embodiments of the present disclosure, as shown in FIG. 3, FIG. 4, and FIG. 5, the liquid crystal display panel manufacturing method according to the present disclosure may include:
providing a first substrate, where the first substrate includes a first electrode;
providing a second substrate, where the second substrate includes a second electrode and color filters, and the second electrode is formed on the color filters;
forming a plurality of photo spacers on the color filters, where an angle between the photo spacers and the second electrode is equal to or less than 90 degrees; and
forming a liquid crystal layer between the first substrate and the second substrate.

In an embodiment of the present disclosure, when the photo spacers 300 are formed (patterned), parts connecting the photo spacers 300 to the color filters 202 may be excessively etched (dry-etched or wet-etched), so that the angle between the photo spacers 300 and the second electrode is equal to or less than 90 degrees, thereby avoiding formation of the second electrode 204 on the photo spacers 300.

The present disclosure reduces problems during manufacturing and production, requires only one single material, and can shorten the production time and reduce equipment investment. Moreover, the angle between the photo spacers 300 and the second electrode 204 on the color filters 202 may be equal to or less than 90 degrees, to avoid formation of the second electrode 204 on the photo spacers 300, thereby avoiding a short circuit between the second electrode 204 and the first electrode 106 on the photo spacers 300.

Terms such as “in some embodiments” and “in various embodiments” are repeatedly used. Usually, the terms do not refer to a same embodiment; but they may also refer to a same embodiment. Words such as “comprise”, “have”, “include” are synonyms, unless other meanings are indicated in the context.

The foregoing descriptions are merely preferred embodiments of the present disclosure, and are not intended to limit the present disclosure in any form. Although the present disclosure has been disclosed above through the preferred embodiments, the embodiments are not intended to limit the present disclosure. Any person skilled in the art can make some equivalent variations or modifications according to the foregoing disclosed technical content without departing from the scope of the technical solutions of the present disclosure to obtain equivalent embodiments. Any simple amendment, equivalent change or modification made to the foregoing embodiments according to the technical essence of the present disclosure without departing from the content of the technical solutions of the present disclosure shall fall within the scope of the technical solutions of the present disclosure.

What is claimed is:

1. A liquid crystal display (LCD) panel, comprising:
a first substrate, comprising a first electrode;
a second substrate, oppositely disposed with respect to the first substrate, wherein the second substrate comprises a second electrode and color filters (CFs), and the second electrode is formed on the color filters;
a plurality of photo spacers (PS), located between the first substrate and the second substrate, and disposed on the color filters, wherein an angle between the photo spacers and the second electrode is equal to or less than 90 degrees; and
a liquid crystal layer, formed between the first substrate and the second substrate.

2. The liquid crystal display panel according to claim 1, wherein the first substrate further comprises a plurality of active switches, and the first electrode is formed on the plurality of active switches.

3. The liquid crystal display panel according to claim 1, wherein the angle between the photo spacers and the second electrode is less than 90 degrees.

4. The liquid crystal display panel according to claim 3, wherein at least some of the photo spacers on the color filters are inverted trapezoidal.

5. The liquid crystal display panel according to claim 1, wherein the angle between the photo spacers and the second electrode is equal to 90 degrees.

6. The liquid crystal display panel according to claim 5, wherein the photo spacers on the color filters are long rectangular.

7. The liquid crystal display panel according to claim 1, wherein the second substrate further comprises a plurality of active switches, and the color filters are formed on the plurality of active switches.

8. A liquid crystal display (LCD) panel manufacturing method, comprising:
providing a first substrate, wherein the first substrate comprises a first electrode;
providing a second substrate, wherein the second substrate comprises a second electrode and color filters (CF), and the second electrode is formed on the color filters;
forming a plurality of photo spacers (PS) on the color filters, wherein an angle between the photo spacers and the second electrode is equal to or less than 90 degrees; and
forming a liquid crystal layer between the first substrate and the second substrate.

9. The liquid crystal display panel manufacturing method according to claim 8, wherein when the photo spacers are formed, the photo spacers are excessively etched, so that the angle between the photo spacers and the second electrode is equal to or less than 90 degrees.

10. The liquid crystal display panel manufacturing method according to claim 8, wherein the angle between the photo spacers and the second electrode is less than 90 degrees.

11. The liquid crystal display panel manufacturing method according to claim 10, wherein at least some of the photo spacers on the color filters are inverted trapezoidal.

12. The liquid crystal display panel manufacturing method according to claim 8, wherein the first substrate further comprises a plurality of active switches, and the first electrode is formed on the plurality of active switches.

13. The liquid crystal display panel manufacturing method according to claim 8, wherein the angle between the photo spacers and the second electrode is equal to 90 degrees.

14. The liquid crystal display panel manufacturing method according to claim 13, wherein the photo spacers on the color filters are long rectangular.

15. The liquid crystal display panel manufacturing method according to claim 8, wherein the second substrate further comprises a plurality of active switches, and the color filters are formed on the plurality of active switches.

16. A liquid crystal display (LCD) panel, comprising:
a first substrate, comprising a first electrode and a plurality of active switches, wherein the first electrode is formed on the plurality of active switches;
a second substrate, oppositely disposed with respect to the first substrate, wherein the second substrate comprises a second electrode and color filters (CF), and the second electrode is formed on the color filters;
a plurality of photo spacers (PS), located between the first substrate and the second substrate, and disposed on the color filters, wherein an angle between the photo spacers and the second electrode is equal to or less than 90 degrees; and
a liquid crystal layer, formed between the first substrate and the second substrate, wherein
either the first substrate or the second substrate comprises color filters, the color filters comprise a plurality of photoresist layers disposed in parallel, and a material of one of the plurality of photoresist layers is the same as a material of the photo spacers;
when the angle between the photo spacers and the second electrode is less than 90 degrees, at least some of the photo spacers on the color filters are inverted trapezoidal; and
when the angle between the photo spacers and the second electrode is equal to 90 degrees, the photo spacers on the color filters are long rectangular.
